(19) United States
(12) Patent Application Publication
(10) Pub. No.: US 2025/0390437 A1
(43) Pub. Date: Dec. 25, 2025

(54) SCALABLE INPUT/OUTPUT MEMORY MANAGEMENT UNIT (IOMMU) COMMAND PROCESSING

(71) Applicant: Advanced Micro Devices, Inc., Santa Clara, CA (US)

(72) Inventor: Wei Sheng, Shanghai (CN)

(73) Assignee: Advanced Micro Devices, Inc., Santa Clara, CA (US)

(21) Appl. No.: 18/748,382

(22) Filed: Jun. 20, 2024

(51) Int. Cl. G06F 12/1027; G06F 12/0808; G06F 12/1009; G06F 13/16

(52) U.S. Cl. CPC G06F 12/1027; G06F 12/0808; G06F 12/1009; G06F 13/1673

(57) ABSTRACT

A data processing system includes an input-output memory management unit (IOMMU) system. The IOMMU system includes a plurality of domain-specific command buffers in which each domain-specific command buffer is associated with a different one of a plurality of domains, and an IOMMU block that caches translations of each of the plurality of domains and controls the translations of each of the plurality of domains responsive to at least one command received from a corresponding domain-specific command buffer.

### BACKGROUND

Some computer systems use a table to keep a list of peripherals that require direct memory access (DMA) address remapping or interrupt remapping. These peripherals may include, for example, a communication controller, a bus bridge, an analog-to-digital or digital-to-analog converter, a graphics processor, a display processor, various human interface devices, and the like. This table is known as the “Device Table,” and it includes information useful for interacting with the input/output peripheral devices. In some computing systems, system software executing on a central processing unit creates and controls the Device Table, while an input-output memory management unit (IOMMU) uses the Device Table to manage interactions with these peripheral devices. In such computing devices, the IOMMU may use information from or based on the Device Table to handle transactions for peripheral devices, including interrupts from/associated with the peripheral devices, address translations for addresses in requests from peripheral devices, and other operations. The Device Table is stored in main or “system” memory and includes entries that store device information for the peripheral devices used in the system. In complex computer system architectures with many peripheral devices, however, the number of transactions occurring between the operating system and the IOMMU may cause inefficiency due to the high overhead of managing these interactions.

### BRIEF DESCRIPTION OF THE DRAWINGS

FIG. 1 illustrates in block diagram form a data processing system with an input/output memory management unit (IOMMU) according to some embodiments;

FIG. 2 illustrates in block diagram form a data processing system with an IOMMU according to the prior art;

FIG. 3 illustrates in block diagram form a data processing system with an IOMMU according to some implementations;

FIG. 4 illustrates in block diagram form a page translation system by which the IOMMU of FIG. 1 may perform a page table walk according to some implementations;

FIG. 5 illustrates a portion of a data processing system with an IOMMU according to some implementations;

FIG. 6 illustrates in block diagram form another data processing system with an IOMMU according to some implementations; and

FIG. 7 illustrates a flow chart showing a technique for input-output device memory management according to some implementations.

In the following description, the use of the same reference numerals in different drawings indicates similar or identical items. Unless otherwise noted, the word “coupled” and its associated verb forms include both direct connection and indirect electrical connection by means known in the art, and unless otherwise noted any description of direct connection implies alternate implementations using suitable forms of indirect electrical connection as well. The following Detailed Description is directed to electronic circuitry, and the description of a block shown in a drawing figure implies the implementation of the described function using suitable electronic circuitry, unless otherwise noted.

### DETAILED DESCRIPTION OF ILLUSTRATIVE IMPLEMENTATIONS

An operating system typically interacts with an IOMMU using a command buffer. The command buffer is a table in memory that stores commands generated by the operating system for the IOMMU during operation. For example, the operating system may close a process related to a particular peripheral and deallocate memory locations for transactions related to the peripheral. It does so by means of an “invalidate” command that invalidates a page table entry associated with a particular IOMMU. In larger computer systems such as servers, the number of processors and input/output (I/O) peripheral devices connected to the central processing unit may become very large. In these situations, IOMMU command transactions may become inefficient due to the number of memory accesses required to complete the invalidation due to ordering rules. For example, the ordering rules for invalidation commands require the IOMMU to wait until enough time has passed such that all other operations that used the translation being invalidated will have completed. In case of multiple commands to be inserted into a single command buffer from multiple workloads, each software workload needs to acquire a “spinlock”.

Once a particular workload acquires the spinlock, it proceeds to insert the command, and then releases the spinlock afterwards, allowing other workloads the chance to acquire it. The other workloads that do not acquire the spinlock have to “spin” until the spinlock is acquired. While spinning, the CPU and software have to wait and burn power while not being productive. For example, the inventor has discovered that clock cycles in a complex system could be wasted due to IOMMU-related spin/lock conditions. According to various implementations described herein, an IOMMU includes domain-specific command buffers, allowing the IOMMU to process multiple IOMMU commands in parallel for each of the different domains, reducing the inefficiency due to spin/locks caused by the single command buffer used in known data processing systems.

A data processing system includes an input-output memory management unit (IOMMU) system. The IOMMU system includes a plurality of domain-specific command buffers in which each domain-specific command buffer is associated with a different one of a plurality of domains, and an IOMMU block that caches translations of each of the plurality of domains and controls the translations of each of the plurality of domains responsive to at least one command received from a corresponding domain-specific command buffer.

A data processing system includes an input-output memory management unit (IOMMU) system. The IOMMU system includes a plurality of command buffers in which each command buffer is associated with a different set of one or more domains of a plurality of domains, in which each domain of the plurality of domains is associated with only one command buffer, and an IOMMU block that caches translations of addresses of each of the plurality of domains and controls the translations of each of the plurality of domains responsive to at least one command received from each of the plurality of command buffers.

A method for input-output device memory management includes sending commands from a plurality of workloads to a plurality of domain-specific command buffers in which each domain-specific command buffer is associated with a different one of a plurality of domains. Translations of each of the plurality of domains are cached in an input-output memory management unit (IOMMU) system. The translations of each of the plurality of domains cached by the IOMMU system are controlled responsive to at least one command received from a corresponding domain-specific command buffer.

Generally, a data processing system uses an IOMMU because drivers for I/O peripherals are not aware of the actual memory resources available in the system. The IOMMU is a circuit that translates a “virtual” memory address provided by the peripheral into a “physical” memory address available from the memory implemented in the system. The means of doing so is through a set of tables in memory, referred to generically as page tables, which allows the IOMMU to perform this translation for different peripheral devices. The translations vary as different devices are enabled or disabled, so the operating system has to perform maintenance of the page tables from time to time. Typically, the maintenance includes invalidating or “deallocating” certain translations in the page tables. Different programs or operating system instances can use different sets of translations, or “domains”, that give I/O devices access to different portions of the physical memory space.

Since modern computer systems can be very complex and require long delay times to access the memory system, maintenance operations can take a long time. While the IOMMU is responding to a particular maintenance command (known as “spinning”), other commands are forced to wait in the command buffer and are “locked” out of performing their maintenance commands. These “spin/lock” cycles cause wasted, unproductive cycles and significant inefficiency in the system.

According to the disclosed implementations, however, a data processing system and method solve the spin/lock problem by providing different command buffers with different address translation domains. In particular, they provide domain-specific command buffers using this technique, and only later commands directed to the same memory management domain are locked out while an earlier command to that domain is spinning. However, commands to other memory management domains can be initiated and processed in parallel.

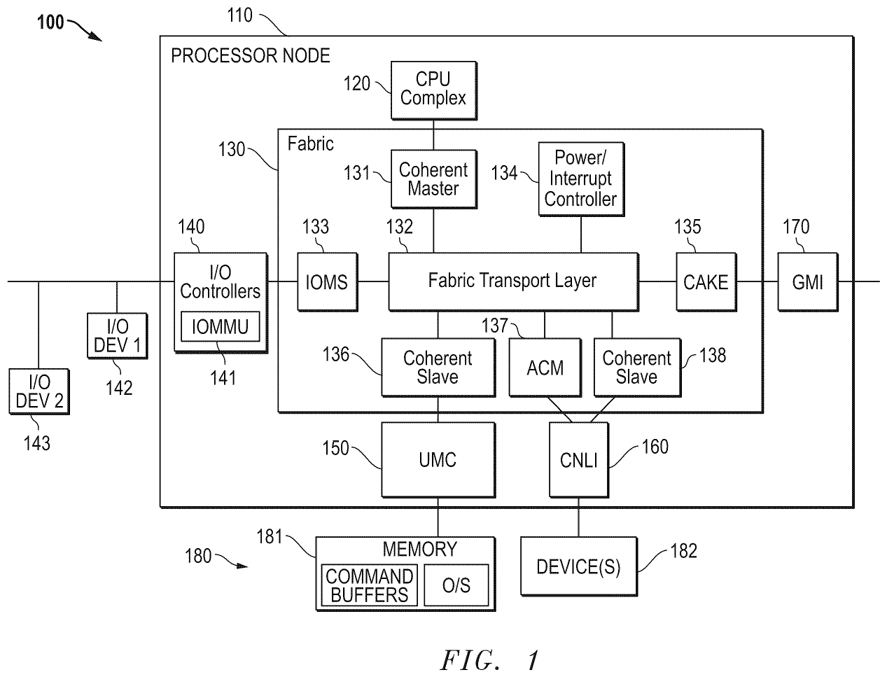

FIG. 1 illustrates in block diagram form a data processing system 100 with an input/output memory management unit (IOMMU) according to some embodiments. Data processing system 100 includes generally a processor node 110 implemented as, for example, a system on chip (SoC), input/output devices 142 and 143, and a memory system 180. Processor node 110 includes a CPU complex 120, a data fabric 130 labelled “FABRIC”, a set of input/output controllers 140 labelled “I/O Controllers”, a memory controller 150 labelled “UMC”, a coherent network layer interface 160 labelled “CNLI”, and a global memory interface controller 170 labelled “GMI”.

CPU complex 120 includes one or more CPU cores each having one or more dedicated internal caches. If it includes multiple CPU cores, CPU complex 120 also can have a shared lower-level cache shared among all the CPU cores.

Data fabric 130 includes a coherent master 131, an input/output master slave 133 labelled “IOMS”, a power/interrupt controller 134, a coherent socket extender 135 labelled “CAKE”, a coherent slave 136, a cache coherent interconnect for accelerators controller 137 labelled “ACM”, and a coherent slave 138, all interconnected through a fabric transport layer 132.

I/O controllers 140 include various controllers and their physical layer interface circuits for protocols such as Peripheral Component Interconnect Express (PCIe) and the like, and an IOMMU 141.

Memory controller 150 performs command buffering, re-ordering, and timing eligibility enforcement for efficient utilization of the bus to external memory, such as double data rate (DDR) and/or non-volatile dual-inline memory module with persistent storage (“NVDIMM-P”) memories.

CNLI 160 routes traffic to one or more external coherent memory devices.

Global memory interface controller 170 performs inter-chip communication to other processor nodes that have their own attached storage that is visible to all processors in the memory map.

Memory system 180 includes a DDR/NVDIMM-P memory 181 connected to memory controller 150, and one or more coherent memory devices sch as a Computer Express Link (CXL) device connected to CNLI 160. Memory system stores an operating system labelled “O/S” and a set of commands buffers for use by IOMMU 141.

Processor node 110 is an exemplary multi-processor circuit that shows the complexity of data processing system 100 and that may be implemented as a system-on-chip (SOC). Data fabric 130 is used to connect various data processing, memory, and I/O components with various storage points for in-process write transactions. For example, coherent slave blocks 136 and 138 support various memory channels and enforce coherency. In the exemplary embodiment, they track coherency and address collisions and support, e.g., 256 outstanding transactions.

In exemplary implementations, IOMMU 141 is a circuit that allows various peripheral devices that have no knowledge of the specific memory resources of data processing system 100 that interacts with the operating system and software applications running on CPU complex 120. In some computing systems, operating system software executing on CPU complex 120 creates and controls a Device Table that identifies peripheral device present in data processing system 100. Using the Device Table and one or more page tables, IOMMU 141 maps peripheral device addresses, known as virtual addresses, to physical addresses corresponding to addresses in memory system 180 using address translation. It performs address translation using either of two processes.

The first process is translation lookaside buffer (TLB) lookup. IOMMU 141 is able to store a limited number of translations of virtual addresses to physical addresses in memory locations internal to the IOMMU. If the virtual address matches an address in the TLB, then IOMMU 141 uses the corresponding translation stored in its internal memory to form the physical address without the need to access memory system 180. IOMMU 141 advantageously uses sub-structures in its TLB to facilitate this lookup in a manner that will be described below.

The second process is known as page table walking. IOMMU 141 uses the page table walking process to obtain the translation of a virtual address into a corresponding physical address if the translation is not stored in its internal TLB. At startup, the operating system running on CPU complex 120 sets up page tables in memory system 180 that define address translations for various peripheral devices. When a peripheral device such as input/output device 142 first attempts to read data from or write data to memory system 180, IOMMU 141 performs page table walking. Page table walking generally occurs as follows. First, IOMMU 141 accesses the Device Table entry assigned to an input/output device 142. The Device Table entry stores a base address in memory system 180 of a first translation table. IOMMU 141 accesses the first translation table in memory system 180 by adding an offset from the base address of the first translation table base address using certain bits of the virtual address. The first translation table entry includes a pointer to a base address of a subsequent, second translation table. IOMMU 141 accesses the second translation table in memory system 180 by adding an offset from the base address of the second translation table base address using other bits of the address. This process can continue through one or more additional levels of translation tables, in which the last lookup allows the IOMMU to provide the physical address corresponding to the virtual address. Once IOMMU 141 finishes the page table walking process, it typically stores the translation in an available entry in the TLB for future use. The available entry may be, for example, an invalid entry or if there are no invalid entries, a least-recently-used entry.

As will be described in greater detail below, the operating system (O/S) running on CPU complex 120 controls the page tables in memory system 180 and the TLB entries in IOMMU 141 by sending commands to the IOMMU through a command buffer. Certain computer systems, such as those for server applications that have many processing nodes and deep peripheral hierarchies, control so many peripheral devices and translation tables that the table walking process produces bottlenecks in the command buffer. Since many several processes are contending for access to these structures will remain idle by creating “spinlocks”, resulting in significant system inefficiency.

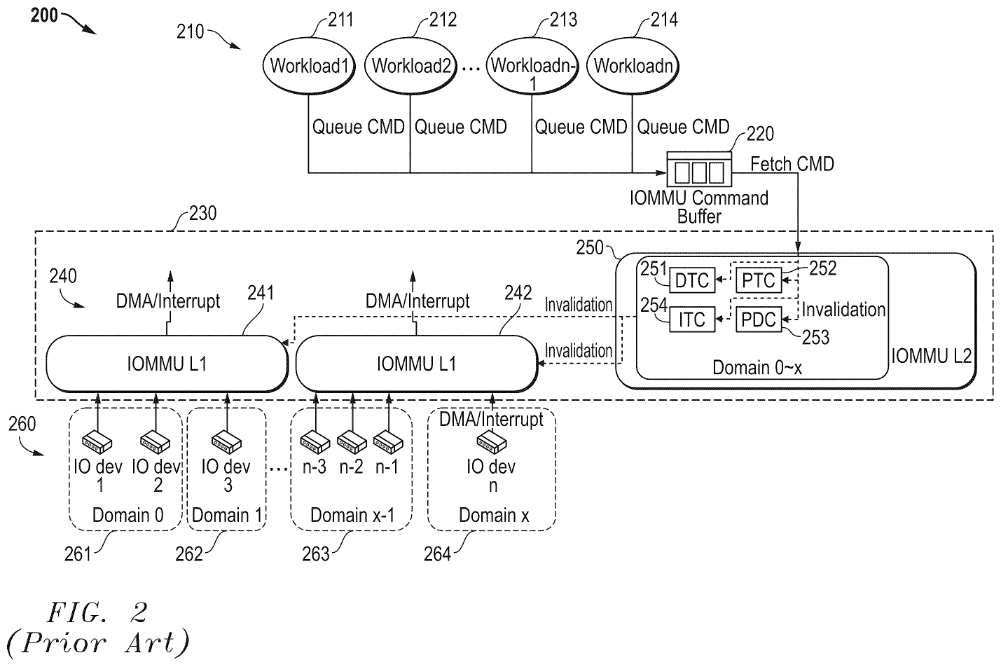

FIG. 2 illustrates in block diagram form a data processing system 200 with an IOMMU according to the prior art. Data processing system 200 includes various hardware and software entities, including generally a set of workloads 210, an IOMMU command buffer 220, an IOMMU 230, and a set of I/O devices 260.

Workloads 210 include four workloads 211, 212, 213, and 214. Workloads 210 are generally user software applications, portions of applications, or program threads running under an operating system of data processing system 200, such as the operating systems known as Windows, MacOS, Linux, IOS, Android, and the like. Each of workloads 211, 212, 213, and 214 interacts with system peripherals and generates commands generically labelled “Queue CMD” that are placed into and queued in IOMMU command buffer 220.

IOMMU command buffer 220 is stored in a region in memory that is dedicated to buffering commands that are generated by workloads 210 and are pending action by IOMMU 230. It receives commands represented as an input connected to the output of each of Workloads 210, and provides individual commands represented as an output labelled “Fetch CMD”. IOMMU command buffer 220 operates as a queue, such as a first-in, first-out (FIFO) quene, in which new commands are added by workloads 210 using a tail pointer and the oldest commands are fetched by IOMMU 230 using a head pointer. An exemplary command is an invalidation command, by which the workload deallocates a portion of physical memory that had been previously assigned to a software application, a portion of a software application, or a program thread. Other exemplary commands include command_wait for command serialization and prefetch_translation for performing a page table walk before the translation is needed.

IOMMU 230 is an exemplary two-level memory management unit for I/O devices having multiple Level-1 (L1) IOMMUs 240 and a single Level-2 (L2) IOMMU 250. IOMMU 230 has an inclusive architecture, in which any TLB entry in an L1 IOMMU is also stored in L2 IOMMU 250. FIG. 2 shows two exemplary L1 IOMMUs, namely L1 IOMMU 241 and L1 IOMMU 242, L1 IOMMU 241 is connected to two domains labelled “DOMAIN 0” and “DOMAIN 1”. VO devices labelled “I/O DEV 1” and “VO DEV 2” are in DOMAIN 0, whereas an I/O device labelled “TO DEV 3” is in DOMAIN 1. Each domain is assigned to one or more I/O devices that operate in the same virtual memory space and therefore share the same virtual-to-physical translation tables.

In response to activity in an I/O device, such as data in a receive first-in, first-out (FIFO) buffer in I/O device 1 exceeding a watermark, I/O device 1 provides a signal to L1 IOMMU 241 that is responsible for Domain 0. As a result of the I/O activity, L1 IOMMU 241 may provide a DMA request signal to a DMA controller to cause the DMA controller to move the data from the FIFO to main memory. Alternatively, I/O device 1 may provide an interrupt request signal to CPU complex 120 to cause it to execute a software routine to read the data from I/O device 1 and store the data in memory, or to process it in some other way.

If the access is not present in the TLB of L1 IOMMU 241, i.e., it “misses” in the TLB of L1 IOMMU 241, then a translation request is provided to L2 IOMMU 250 to determine whether L2 IOMMU 250 caches the translation in its TLB. In response, L2 IOMMU 250 accesses its own TLB to see if it caches the translation. L2 IOMMU 250 has its own TLB that includes four sub-structures, including a device table cache 251 labelled “DTC”, a page table cache 252 labelled “PTC”, a page directory cache 253 labelled “PDC”, and an interrupt table cache 254 labelled “ITC”. Device table cache 251 stores attributes of the region and assigns an I/O device to a page directory base address, and interrupt table cache 254 assigns an available interrupt request in the microarchitecture of the processor node to the virtual memory address. Page directory cache 253 and page translation cache 252 are used to map the virtual memory address to respective tables in memory for portions of a two-level translation process that will be described in more detail below.

L2 IOMMU 250 reads commands from IOMMU command buffer 220 and responds to them by taking a specific action or actions specified by the command. Generally, the commands include invalidation commands generated as a result of deallocation of memory addresses to processes by the operating system, as well as various other commands as noted above. L2 IOMMU 250 fetches the next command from IOMMU command buffer 220, processes it, and updates the head pointer to IOMMU command buffer 220, such that valid commands exist between the head pointer and the tail pointer, and invalid commands exist between the tail pointer and the head pointer, in the direction of command storage.

A problem arises in computer systems with complex system architectures. For example, in complex server architectures, the number of processor nodes and input/output (I/O) peripheral devices connected to the central processing unit may become very large. In these situations,. The result is that spinlocks may take a long time to resolve with cycles being wasted while in spinlock conditions.

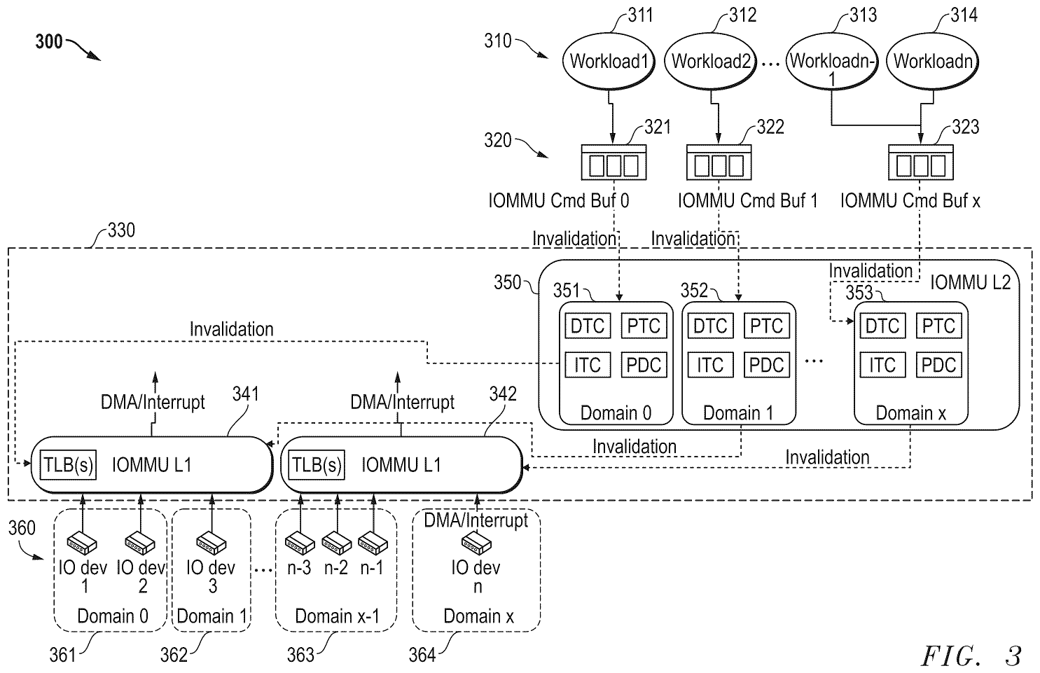

FIG. 3 illustrates in block diagram form a data processing system 300 with an IOMMU according to some implementations. Data processing system 300 includes various hardware and software entities, including a set of workloads 310, a set of domain-specific command buffers 320, an IOMMU 330, and a set of I/O devices 360.

Workloads 310 include an exemplary set of four workloads 311, 312, 313, and 314. Workloads 310 are user software applications, portions of applications, or program threads running under an operating system of data processing system 300, such as the operating systems known as Windows, MacOS, Linux, IOS, Android, and the like. Each of workloads 311, 312, 313, and 314 interacts with system peripherals and may cause the operating system to generate commands that are placed into a domain-specific command buffer.

Each of domain-specific commands buffers 320 occupies a region in memory that is dedicated to buffering commands that are generated by one or more of workloads 310 and are pending action by IOMMU 330. It receives commands represented as an input connected to the output of one or more of workloads 310, and provides commands represented output labelled generically “INVALIDATION”. Each domain-specific command buffer operates as a queue, such as a first-in, first-out (FIFO) queue, in which commands are added by a corresponding one of workloads 310 using a tail pointer and removed by a respective one of domain-specific commands buffers 320 using a head pointer.

IOMMU 330 is a two-level memory management unit for I/O devices having multiple Level-1 (L1) IOMMUs 340 and a single level-2 (L2) IOMMU 350. IOMMU 330 has an inclusive architecture, in which any TLB entry in an L1 IOMMU is also stored in the L2 IOMMU.

FIG. 3 shows two exemplary L1 IOMMUs 341 and 342. L1 IOMMU 341 is connected to two domains labelled “DOMAIN 0” and “DOMAIN 1”. I/O devices labelled “I/O DEV 1” and “I/O DEV 2” are in DOMAIN 0, whereas an I/O device labelled “I/O DEV 3” is in DOMAIN 1. Each domain defines a set of devices that operate in the same virtual memory space and therefore share the same virtual-to-physical translation tables, L1 IOMMU 341 has a set of TLBs for storing recent translations, and an output for providing a DMA request or an interrupt when the translation is complete.

L2 IOMMU 350 includes a set of TLBs including a TLB 351 for domain-specific command buffer 321, a TLB 352 for domain-specific command buffer 322, and a TLB 353 for domain-specific command buffer 323. Each TLB includes a DTC, a PTC, a PDC, and an ITC as described above with respect to FIG. 2 for the corresponding domain.

In response to IOMMU 330 fetching an invalidate command for a certain domain, it creates a spin/lock condition that locks it from issuing other commands for this domain while the current command is latent (i.e., it is spinning), IOMMU 330 completes the command before fetching another command for that domain. However, by employing multiple domain-specific command buffers 320, IOMMU 330 can process multiple IOMMU commands in parallel for each of the different domains, reducing the inefficiency due to spin/locks caused by the single command buffer used in data processing system 200.

The operation of the remaining elements not specifically noted are as described for corresponding elements of FIG. 2.

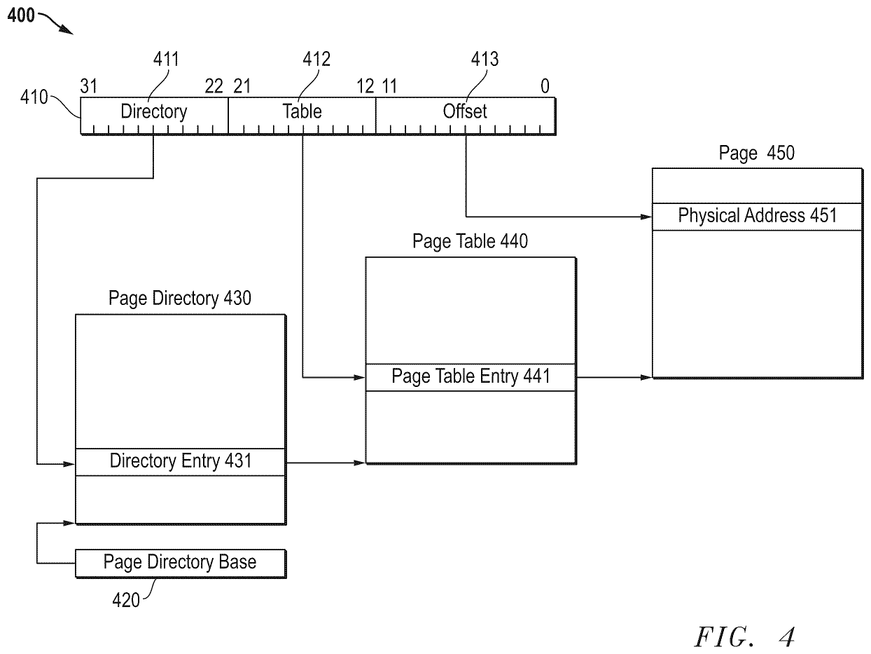

FIG. 4 illustrates in block diagram form a page translation system 400 by which IOMMU 141 of FIG. 1 may perform a page table walk according to some implementations. Page translation system 400 shows an example of a two-level page table lookup. An address 410 includes 32 bits for an address space of 4 gigabytes (GB). Address 410 includes a 10-bit Directory field 411 in address bits [31:22], a 10-bit Table field 412 in address bits [21-12], and a 12-bit Offset field 413 in bits [11:0]. When performing a page table walk, IOMMU 141 first determines the base address of the Page Directory located in PAGE DIRECTORY BASE register 420.

Starting from the PAGE DIRECTORY BASE address, which can be stored in a privileged register of IOMMU 141, IOMMU 141 adds an offset indicated by the Directory field of the virtual address. Thus, Page Directory 430 has 2¹⁰=1024 possible entries, each containing a 32-bit address. In the example shown in FIG. 4, Directory field 411 points to a directory entry 431 in Page Directory 430. Directory entry 431 forms the base address of a Page Table 440.

Starting from the base address of a Page Table 440, IOMMU 141 adds an offset indicated by the Table field of the virtual address. Thus, Page Table 440 has 2¹⁰=1024 possible entries, each containing a 32-bit address. In the example shown in FIG. 4, Table field 412 points to a page table entry 441 in Page Table 440. Page table entry 441 forms the base address of a memory page 450.

Starting from page table entry 441, IOMMU 141 adds an offset indicated to the Offset field of the virtual address to form the physical address. Thus Page 450 has 2¹²=4096 possible 32-bit locations.

In order to store the entry in the TLB, IOMMU 141 stores a virtual address and corresponding Directory and Table fields. Thus, IOMMU 141 can determine the physical address without performing a page table walk as long as the higher-order address bits of the input address match the corresponding higher-order address bits of the virtual address of a valid entry stored in the TLB.

It should be apparent that in other implementations, an IOMMU can perform a page table lookup of more than two levels. Moreover, the sizes of the page directory and the page table (and any other structures used when implementing a page table lookup of more than two levels) as well as different virtual address sizes, such as 40 bits, may be used.

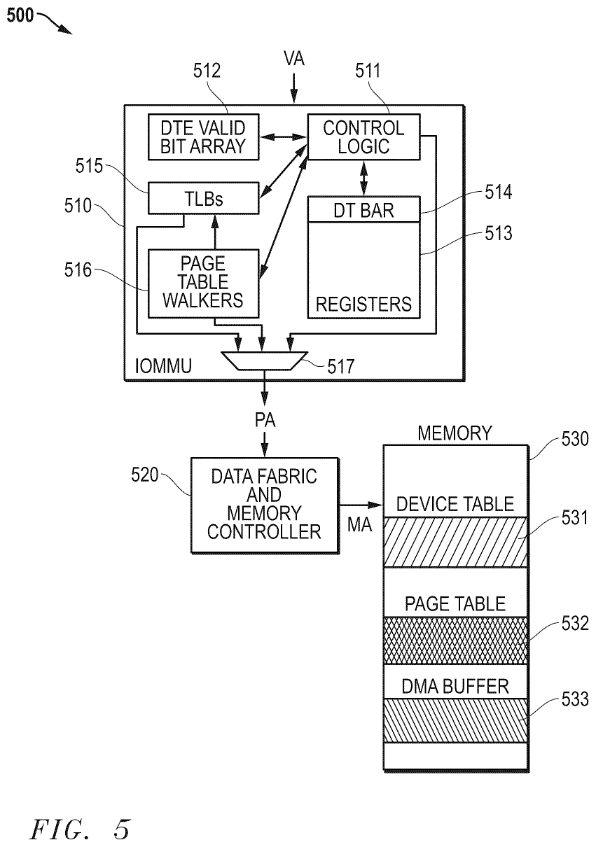

FIG. 5 illustrates a portion of a data processing system 500 having an input/output memory management unit 510 according to some implementations. Data processing system 500 includes generally input/output memory management unit 510, a data fabric and memory controller 520, and a system memory 530, as well as other components that were described with respect to FIG. 1 but will not be discussed further here.

Input/output memory management unit 510 has an input for receiving a virtual address labelled “VA” and an output for providing a physical address labelled “PA”. Input/output memory management unit 510 includes generally a control logic circuit 511 labelled “CONTROL LOGIC”, a device table entry valid bit array 512 labelled “DTE VALID BIT ARRAY”, a set of control registers 513 labelled “REGISTERS” including a device table base address register 514 labelled “DT BAR”, a set of translation look-aside buffers 515 labelled “TLBs”, a set of page table walkers 516 labelled “PAGE TABLE WALKERS”, and an output selector 517. Data fabric and memory controller 520 has an input for receiving the physical address from input/output memory management unit 510, and an output for providing a memory address labelled “MA”. System memory 530 has an input for receiving the memory address, and an input/output port for providing data in response to a read command over a data bus (not shown), or receiving data in response to a write command over the data bus. System memory 530 has three regions of interest, including a device table 531, a page table 532, and a direct memory access buffer 533 labelled “DMA BUFFER”.

Control logic circuit 511 controls the operations of the other circuits in input/output memory management unit 510. In response to receiving a virtual address labelled “VA”, control logic circuit 511 first reads the corresponding valid bit in device table entry valid bit array 512. Device table entry valid bit array 512 is implemented with high-speed static random access memory (SRAM) and is accessible by control logic circuit 511 at high speed.

If the corresponding valid bit is in a first logic state indicating a valid state, e.g., a binary “1”, and control logic circuit 511 determines that a valid translation is cached in translation look-aside buffers 515, control logic circuit 511 uses the translation information in the Device Table entry to create a physical address. It provides the physical address to an input of selector 517, and causes selector 517 to output the selected physical address as the PA signal.

If the corresponding valid bit indicates the valid state and control logic circuit 511 determines that a valid translation is not cached in translation look-aside buffers 515, then control logic circuit 511 first fetches the Device Table entry from device table 531 of system memory 530 through data fabric and memory controller 520. Based on various attributes in the corresponding Device Table entry, such as the page table root pointer, control logic circuit 511 causes a page table walker of page table walkers 516 to walk the page tables stored in page table 532 to create the translation. Each page table walker of page table walkers 516 is a semi-autonomous state machine that automatically generates addresses to access the indicated page table in page tables 532 to fetch and construct the translation. After the selected page table walker creates the translation, control logic circuit 511 stores the translation in translation look-aside buffers 515 for future reference, and replaces an older translation lookaside buffer entry such as one that is least recently used. Control logic circuit 511 then causes the page table walker to output the translation through selector 517 as the indicated PA for accessing direct memory access buffer 533.

If the corresponding valid bit indicates the invalid state, then control logic circuit 511 passes the virtual address through as the physical address without performing any address translation or privilege checking. In this case, control logic circuit 511 provides the virtual address as the physical address and without accessing device table 531.

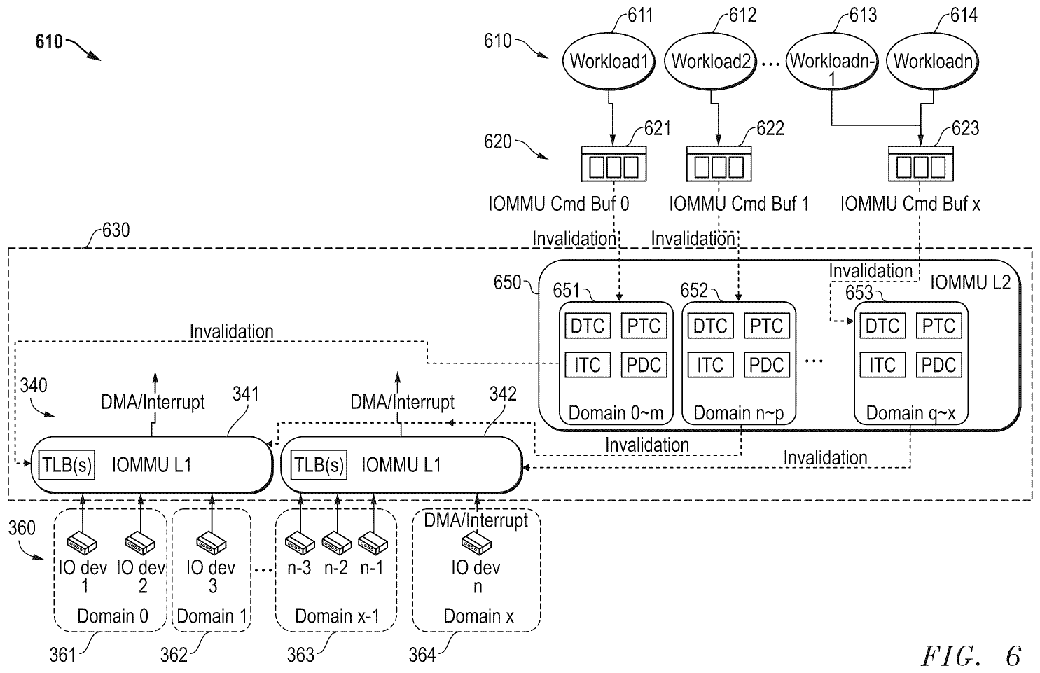

FIG. 6 illustrates in block diagram form a data processing system 600 with an IOMMU according to some implementations. Data processing system 600 includes various hardware and software entities that are the same or similar as those shown in data processing system 300 of FIG. 3, and similar elements operate as previously described and will not be described further here.

Data processing system 600 includes an exemplary set of workloads 610, a group of domain-set specific IOMMU command buffers 620, and an IOMMU 630. Workloads 610 are similar to workloads 310 of FIG. 1, except that they include a representative set of workloads 611, 612, 613, and 614. Workload 611 operates with I/O devices in a set of domains 0 through m. Workload 612 operates with I/O devices in a set of domains n through p. Each of workloads 613 and 614 operates with I/O devices in a set of domains q through x. Similarly, domain-set specific IOMMU command buffers 620 include command buffers for use with a set of domains, including an IOMMU command buffer 621 for set of domains 0 through m, an IOMMU command buffer 622 for set of domains n through p, and an IOMMU command buffer 622 for set of domains q through x. IOMMU 630 includes L1 IOMMU 341 and L1 IOMMU 342 as described above, and an L2 IOMMU 650. L2 IOMMU 650 includes a TLB 651 connected to IOMMU command buffer 621 for domains 0 through m, a TLB 652 connected to IOMMU command buffer 622 for domains n through p, and a TLB 653 connected to IOMMU command buffer 623 for domains q through x.

By employing multiple domain-set specific IOMMU command buffers 620, data processing system 600 reduces the amount of wasted spin/lock cycles by introducing a degree of parallelism that is less than the parallelism of domain-specific command buffers 320 of FIG. 3. However it reduces the amount of memory needed for the command buffers, and the amount of circuit area needed for the TLB storage structures, namely the DTC, PTC, PDC, and ITC, in L2 IOMMU 650. Thus, data processing system 600 provides a different tradeoff between IOMMU circuit area and system performance that may be desirable in some systems.

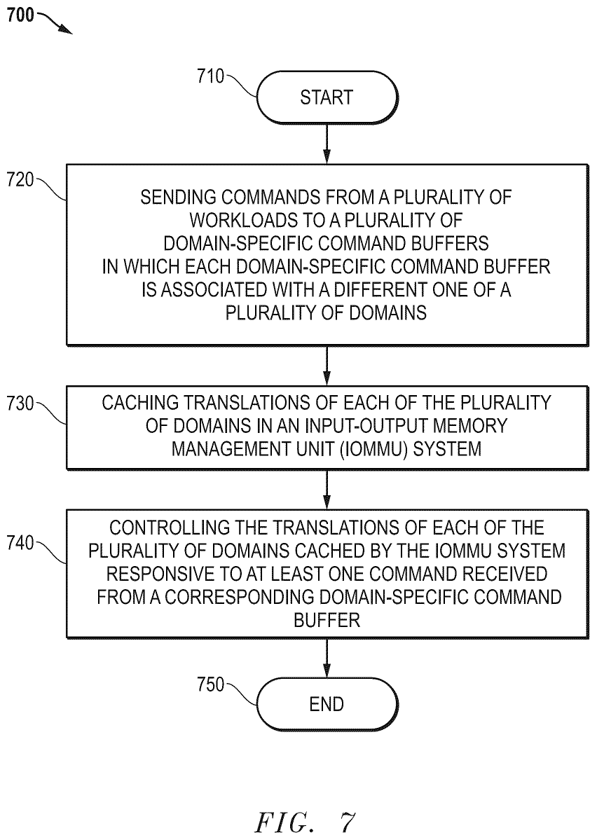

FIG. 7 illustrates a flow chart 700 for input-output device memory management according to some implementations. Flow chart 700 starts in a box 710.

An action box 720 includes sending commands from a plurality of workloads to a plurality of translation lookaside buffers using a corresponding plurality of domain-specific command buffers in which each domain-specific command buffer is associated with a different one of a plurality of domains. For example, sending the commands may include sending invalidation commands.

An action box 730 includes caching translations of each of the plurality of domains in an input-output memory management unit (IOMMU) system.

An action box 740 includes controlling the translations of each of the plurality of domains by the IOMMU system responsive to commands received from a corresponding domain-specific command buffer.

Flow chart 700 ends in a box 750.

In some embodiments, the flow chart may further include accessing a translation lookaside buffer to translate a first virtual address into a first physical address if a translation of the first virtual address into the first physical address is stored in the translation lookaside buffer, and walking at least one table in a memory system to form the translation of the first virtual addresses into the first physical addresses if the translation of the first virtual address into the first physical address is not stored in the translation lookaside buffer. In this case, walking the at least one table may include accessing a page directory in response to first bits of a virtual address, accessing a page table in response to second bits of the virtual address and accessing the page directory, and forming the first physical address in response to third bits of the virtual address and accessing the page table. In this case, the flow chart may further include storing the translation of the first virtual address into the first physical address in a least recently used entry of the translation lookaside buffer.

Thus, a data processing system and method have been described that can be used to significantly reduce or eliminate the amount of time an IOMMU and processing workload is stuck in unproductive “spin/lock” cycles while waiting to execute translation table management commands sent from various processes. This technique is especially useful in complex systems with many processing nodes and deep memory access hierarchies, such as Peripheral Component Interconnect Express (PCIe) systems with deep hierarchies and fabric attached memory. By using domain-specific command buffers, or multiple domain-set specific command buffers, the IOMMU operations can take place in parallel and reduces system slowdown due to spin/lock cycles.

While particular implementations have been described, various modifications of these implementations will be apparent to those skilled in the art. For example, different virtual and physical address sizes can be used in different implementations. Moreover, different page sizes with different numbers of page tables can also be supported. Also, the techniques described herein are applicable to single-level IOMMUs, are two-level IOMMUs with multiple L1 MMUs and one L2 MMU as described herein, as well as other IOMMU architectures. The number of peripheral devices assigned to a memory management domain may also vary. The type of commands that control the IOMMU and create ordering dependencies and therefore spin/lock conditions will also vary in different implementations.

Accordingly, it is intended by the appended claims to cover all modifications of the disclosed implementations that fall within the scope of the disclosed implementations.

What is claimed is:

1. A data processing system comprising:
a plurality of domain-specific command buffers in which each domain-specific command buffer is associated with a different one of a plurality of domains; and
an input-output memory management unit (IOMMU) that caches translations of each of the plurality of domains and controls the translations of each of the plurality of domains responsive to at least one command received from a corresponding domain-specific command buffer.

2. The data processing system of claim 1, wherein:
each domain of the plurality of domains is characterized by a respective set of translation tables.

3. The data processing system of claim 1, wherein:
the at least one command received from the corresponding domain-specific command buffer comprises an invalidation command.

4. The data processing system of claim 1, wherein:
the input-output memory management unit comprises a two-level IOMMU having a plurality of level-1 input-output memory management unit and a level-2 input-output memory management unit coupled to each of the plurality of level-1 input-output memory management units.

5. The data processing system of claim 1, wherein the input-output memory management unit is operative to:
translate a first virtual address into a first physical address using an entry of a translation lookaside buffer if a translation of the first virtual address into the first physical address is stored in a corresponding translation lookaside buffer; and
walk a page table in a memory system to form the translation of the first virtual addresses into the first physical addresses if the translation of the first virtual address into the first physical address is not stored in the corresponding translation lookaside buffer.

6. The data processing system of claim 5, wherein the input-output memory management unit is adapted to:
store the translation of the first virtual address into the first physical address in a least recently used entry of the corresponding translation lookaside buffer of the input-output memory management unit.

7. The data processing system of claim 1, further comprising:
a data fabric;
a memory controller coupled to the data fabric and adapted to be coupled to a memory system; and
a plurality of input/output devices coupled to the input-output memory management unit, wherein in response to a request to read or write data from a first input/output device, the input-output memory management unit translates a virtual address of the request to a physical address according to a domain assigned to the first input/output device.

8. A data processing system comprising:
a plurality of command buffers in which each command buffer is associated with a different set of one or more domains of a plurality of domains, in which each domain of the plurality of domains is associated with only one command buffer; and
an input-output memory management unit that caches translations of addresses of each of the plurality of domains and controls the translations of each of the plurality of domains responsive to at least one command received from each of the plurality of command buffers.

9. The data processing system of claim 8, wherein:
each of the plurality of command buffers is associated with a different one of the plurality of domains.

10. The data processing system of claim 8, wherein the input-output memory management unit comprises:
a first L2 translation lookaside buffer associated with a first command buffer that covers a first plurality of domains; and
a first plurality of L1 translation lookaside buffers associated with the first plurality of domains,
wherein in response to the first L2 translation lookaside buffer receiving an invalidation request from the first command buffer, the input-output memory management unit searches each of the first plurality of L1 translation lookaside buffers for matches and invalidates an entry corresponding to the invalidation request.

11. The data processing system of claim 8, wherein the input-output memory management unit comprises:
a plurality of L2 translation lookaside buffers associated with a corresponding plurality of command buffers and a like plurality of domains, respectively;
a first L1 translation lookaside buffer associated with the plurality of L2 translation lookaside buffers and the like plurality of domains; and
wherein in response to receiving an invalidation request from one of the plurality of L2 translation lookaside buffers, the input-output memory management unit searches the first L1 translation lookaside buffer for a match and invalidates an entry corresponding to the invalidation request.

12. The data processing system of claim 8, wherein:
each one of the plurality of domains is characterized by a respective set of translation tables.

13. The data processing system of claim 8, wherein:
the at least one command received from each of the plurality of command buffers comprises an invalidation command.

14. The data processing system of claim 8, wherein the input-output memory management unit is operative to:
access a translation lookaside buffer to translate a first virtual address into a first physical address if a translation of the first virtual address into the first physical address is stored in the translation lookaside buffer; and
walk at least one table in a memory system to form the translation of the first virtual addresses into the first physical addresses if the translation of the first virtual address into the first physical address is not stored in the translation lookaside buffer.

15. The data processing system of claim 14, wherein the input-output memory management unit is adapted to:
store the translation of the first virtual address into the first physical address in a least recently used entry of the translation lookaside buffer of the input-output memory management unit.

16. A method for input-output device memory management, comprising:
sending commands from a plurality of workloads to a plurality of domain-specific command buffers in which each domain-specific command buffer is associated with a different one of a plurality of domains;
caching translations of each of the plurality of domains in an input-output memory management unit; and
controlling the translations of each of the plurality of domains cached by the input-output memory management unit responsive to at least one command received from a corresponding domain-specific command buffer.

17. The method of claim 16, wherein:
sending the commands comprises sending an invalidation command.

18. The method of claim 16, further comprising:
accessing a translation lookaside buffer to translate a first virtual address into a first physical address if a translation of the first virtual address into the first physical address is stored in the translation lookaside buffer; and
walking at least one table in a memory system to form the translation of the first virtual addresses into the first physical addresses if the translation of the first virtual address into the first physical address is not stored in the translation lookaside buffer.

19. The method of claim 18, wherein walking the at least one table comprises:
accessing a page directory in response to first bits of a virtual address;
accessing a page table in response to second bits of the virtual address and accessing the page directory; and
forming the first physical address in response to third bits of the virtual address and accessing the page table.

20. The method of claim 19, further comprising:
storing the translation of the first virtual address into the first physical address in a least recently used entry of the translation lookaside buffer.
